(19) United States
(12) Patent Application Publication
(10) Pub. No.: US 2025/0103674 A1
(43) Pub. Date: Mar. 27, 2025

(54) MULTI-OBJECTIVE OPTIMIZATION BASED ON DEEP FIRST SEARCH WITH BACKTRACKING AND SEARCH SPACE REDUCTION

(71) Applicant: REFINITIV US ORGANIZATION LLC, New York, NY (US)

(72) Inventor: Hayden MELTON, Philadelphia, PA (US)

(21) Appl. No.: 18/891,183

(22) Filed: Sep. 20, 2024

Related U.S. Application Data
(60) Provisional application No. 63/584,514, filed on Sep. 22, 2023.

(51) Int. Cl. G06F 17/11; G06Q 40/04

(52) U.S. Cl. CPC G06F 17/11; G06Q 40/04

(57) ABSTRACT

The disclosure relates to multi-objective optimization based on Deep First Search (“DFS”) with backtracking and search space reduction. For example, a system may access a message comprising an order and a plurality of codes, wherein unique combinations of codes each define a choice of codes that is to be searched against a second plurality of codes, and wherein permutations of pairwise checks between the choice of codes and the second plurality of codes define a search space. The system may execute a Deep-First Search (“DFS”) with backtracking on the reduced search space until an optimum objective for each choice of code from among the plurality of codes is found. The system may identify a permutation of orders based on the codes that gave the optimum objective for each choice of code derived from the unique combinations of one or more codes.

### RELATED APPLICATIONS

This application claims priority to U.S. Provisional Patent Application No. 63/584,514, filed Sep. 22, 2023, entitled “Credit-Screening and Credit-Checking for Participants Having a Plurality of Credit Codes,” which is incorporated by reference in its entirety herein.

### BACKGROUND

Trading in the spot FX (foreign exchange) market conventionally requires the existence of bilateral credit relationships between parties to the trade. On electronic spot FX trading venues these bilateral relationships usually come into existence when, through the venue's credit administration interface, a participant extends credit lines to other such participants on the venue. When those credit lines are mutually extended between a pair of participants on the venue those participants can trade with one another on it. Credit lines between a pair of participants on electronic spot FX trading venues may be more complex than they might otherwise seem at first blush, see e.g., U.S. patent application Ser. No. 17/886,587 entitled “Deterministic Credit System” for an overview of the nature of such lines. While it may be true that between a pair of ‘credit codes’ it is the smallest line between them that is controlling, determining what is controlling with respect to credit is not straightforward when a participant has a plurality of credit codes, e.g., by virtue of that participant having multiple prime brokers.

To avoid any complications that may arise from a participant having multiple credit codes, conventional electronic spot FX trading venues tend to perform both credit-screening and credit-checking (exclusively) on a per credit code basis, and not on a per participants basis. This may lead to several problems. First, excessive network bandwidth may be consumed in distributing credit-screened market data because as many updates as a participant has credit codes are produced (as opposed to just one credit-screened update that subsumes all a participant's credit codes). Second, a participant is forced to arbitrate between a plurality of credit-screened updates by credit code to determine which credit code is best to use when sending a liquidity-taking order. Third, owing to the nature of credit lines on a venue, the aggregate amount of liquidity displayed across all a participant's credit codes in their credit-screened market data will generally overstate that which is actually available to them. Fourth, duplicate liquidity and knock-on effects associated with credit drawdowns that occur during matching in the presence of multiple credit codes-effects that are not observable in the per credit code screened market data-will generally prevent the participant obtaining best execution for a given quantity. Fifth, to the extent that the controlling credit line on a credit code falls beneath the minimum trade size on the venue, there is no way for a participant to ‘scavenge’ across multiple such credit codes this residual credit and combine it such that the minimum trade size on the venue is met and they can continue to trade and/or make more efficient use of credit across their distinct credit codes.

### SUMMARY

The disclosure relates to systems, methods, and computer-readable media for multi-objective optimization based on Deep-First Search (DFS) with backtracking and search space reduction. One example in which DFS may be used to explore a search space to optimize multiple objectives is to search for the best price while maximizing use of credit lines for orders. To obtain the best price(s) in both credit-screening and credit-checking for a participant having a plurality of credit codes on an electronic trading venue, a sequence of small taker orders having either non-increasing or non-decreasing limit prices is chosen from a plurality of such sequences. The plurality of sequences is generated by fixing the size of the small taker orders then performing a depth-first search (DFS) to distribute the participant's credit codes among those orders. The venue's credit system is used to evaluate the price(s) that would result from each such sequence of orders, and the sequence with the best price(s) is chosen. Additional inputs to and techniques within the search function are advantageously employed to constrain the search space, e.g., removing resting orders from the book where a bilateral credit relationship does not exist; marking up remaining resting orders with the specific credit code(s) to which it has bilateral credit; computing the theoretical bound on the best price(s) on a partial (or the empty) sequence without regard for the credit drawdowns that would otherwise result; and so on.

### BRIEF DESCRIPTION OF THE DRAWINGS

Features of the present disclosure may be illustrated by way of example and not limited in the following Figure(s), in which like numerals indicate like elements, in which:

FIG. 1 illustrates a schematic example of a system environment for credit screening and credit checking for participants each having a plurality of credit codes;

FIG. 2 illustrates a schematic example of participants with private credit codes through broker entities;

FIG. 3 illustrates a schematic of an electronic trading venue (“ETV”) that performs multi-objective optimization through deep-first search with backtracking and search space reduction for a plurality of credit codes.

FIG. 4 illustrates an example of a method for multi-objective optimization through deep-first search with backtracking and search space reduction for checking a plurality of credit codes;

FIG. 5 illustrates an example of a method for evaluating whether DFS conditions have been met;

FIG. 6 illustrates an example of a method for generating an input sequence for input to a best-ex search function involving a plurality of credit codes;

FIG. 7 illustrates an example of a method for the best-ex search function;

FIG. 8A illustrates an example of a method for multi-objective optimization through deep-first search with backtracking and search space reduction;

FIG. 8B illustrates another example of a method for multi-objective optimization through deep-first search with backtracking and search space reduction; and

FIG. 9 illustrates an example of a computer system illustrated in FIGS. 1 and 3.

### DETAILED DESCRIPTION

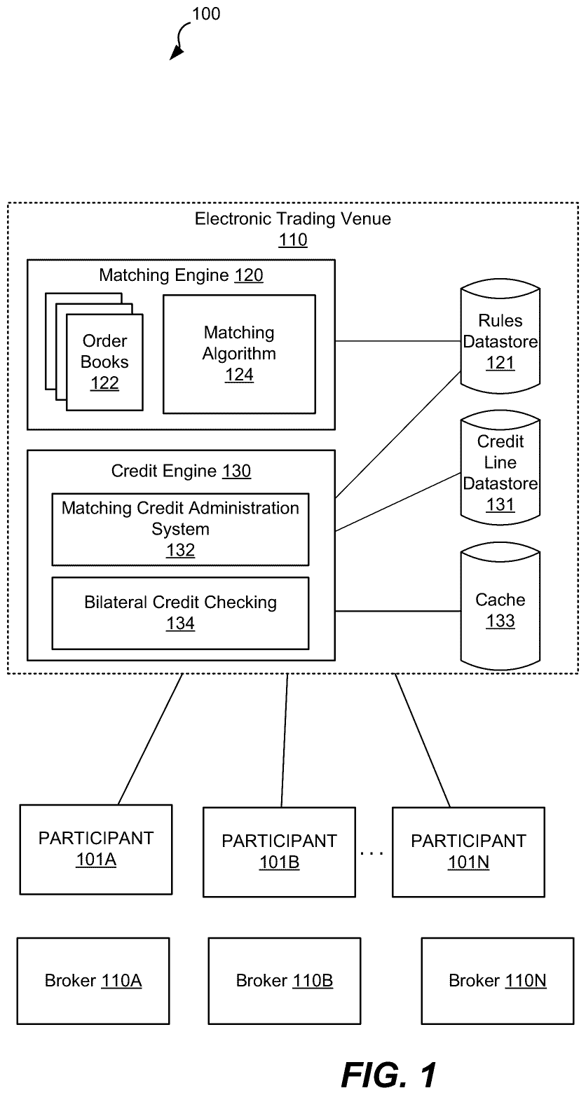

FIG. 1 illustrates a schematic example of a system environment 100 for credit screening and credit checking for participants each having a plurality of credit codes. In the system environment 100, a plurality of market participants 101 (illustrated as market participants 101A-N) may submit messages to an Electronic Trading Venue (“ETV”) 110. Each message may encode a subscription, an order, or other information.

The ETV 110 may include a matching engine 120, a credit system 130, and/or components. The matching engine 120 may include or interface with one or more order books 122 to match orders using a matching algorithm 124. The matching algorithm 124 may match orders according to rules stored in the rules datastore 121.

The credit system 130 may include a matching credit administration system 132, bilateral credit checking 134, and/or other components or functions. The matching credit administration system 132 may set participant-configured credit lines and store them in the credit line datastore 131 for retrieval and processing via bilateral credit checking 134. Bilateral credit checking 134 is a process in which bilateral credit between counterparties is screened for credit-screened market updates for specific participants or checked for matching orders submitted by participants.

Financial instruments that are traded on the ETV 110 may be centrally or bilaterally cleared. In the case of bilateral clearing a credit relationship must exist between the two counterparties for a trade to occur between them. On ETVs implementing pre-trade anonymity among participants it is the ETV that must decide when price-compatible contra-orders for an instrument are eligible to form a trade. The component of the ETV 110 that is typically responsible for doing this is often referred to as the credit engine. On conventional ETVs hosting instruments that trade on the basis of bilateral credit trades are initially formed inside the matching engine component using attributes of orders such as price, side and time, and those partially formed trades are subsequently sent with counterparty information to the credit engine for credit checking. If credit checking succeeds the trade is completed; if not it has failed and the trade is unwound.

To facilitate credit screening and/or credit checking, each market participant 101, also referred to as a counterparty, will be associated with and identified by a respective credit code. A credit code is a unique identifier that is assigned to a counterparty for credit screening and credit checking purposes. In some instances, a bilateral credit relationship must exist between a pair of counterparties for them to be able to trade with one another on an Electronic Trading Venue (“ETV”) 110. A counterparty may have multiple branches all over the world, and those branches are subject to different regulatory regimes or other regulations. In these instances, each branch may be assigned with its respective credit code. The credit code may include or otherwise be associated with an alphanumeric character string that identifies the counterparty and/or specific branch. These credit codes may be published on the platform to others so that they may readily identify the counterparty and/or branch of the counterparty.

The ETV 110 may provide a matching credit administration system 132 for the counterparties to establish credit line entries to extend credit to one another. A credit line entry includes one or more credit codes of one or more extending counterparties, one or more credit codes of one or more receiving counterparties, an amount of credit extended, and a type of credit extended. Using the matching credit administration system 132, a counterparty may extend, individually and/or in aggregate, credit to other counterparties. An example of one of these credit line entries may be formatted and stored as a record in the form (other formats may be used):
“Credit Code of Extending party→Credit Code of Receiving party Amount Type”

If multiple credit codes are used:
“{Credit Code 1 Extending, Credit Code 2 Extending, . . . }→{Credit Code 1 Receiving, Credit Code 2 Receiving, . . . } Amount Type”

To illustrate, a bank counterparty named “AAA” may have two credit codes: AAAZ for their Zurich branch and AAAL for their London branch. Another bank counterparty named “BBB” may wish to extend credit to AAA. To do this, BBB would create one or more credit line entries via the matching credit administration system 132. An example credit line (1) may be formatted as:

{BBBL,BBBN}→{AAAZ,AAAL} USD100Mio Gross (1)

The above credit line encodes that in aggregate across both of BBB's credit codes, BBB is extending an amount “100 million USD” of type “gross” credit to AAA, in aggregate across both AAA's codes. Generally, only BBB can extend credit from BBB's codes. But BBB can extend credit to any other codes of its choosing in the interbank market. Any participant cannot see who has extended credit back to them. Each can only see credit they have extended outward to others. To further illustrate, BBB may further enter these credit lines (2) and (3):

{BBBL,BBBN}→AAAZ USD75Mio Gross (2)

{BBBL,BBBN}→AAAL USD60Mio Gross (3)

BBB in aggregate across both its codes is extending to AAA Zurich (AAAZ) only 75 million USD gross, and BBB in aggregate across both its codes is extending to AAA London (AAAL) only 60Mio USD gross.

Based on credit lines (1), (2), and (3), BBB is willing to extend AAA as a whole 100mio USD gross credit, but is not willing to extend more than 75Mio to its Zurich branch, and not more than 60Mio to its London branch. There may exist various reasons such as geopolitical, regulatory or legal reasons for BBB to configure these ‘overlapping’ lines. With thousands of these types of credit lines in the system, the number of combinations and permutations of credit lines become quite complex and computationally difficult to analyze, especially when the venue must perform real-time processing of millions of orders.

Another problem that arises is identifying which credit line from among a plurality of credit lines associated with a participant is controlling. For example, it cannot be determined which of the three (unilateral) credit lines (1), (2), and (3), is controlling because this determination depends on the extent to which those lines have been drawn down by trades. For instance, if the second credit line {BBBL, BBBN}→AAAZ USD75Mio Gross has been drawn down to zero (because 75mio of trades have occurred between them), then at most only 25Mio can be left on the third credit line ‘{BBBL, BBBN}→AAAL USD60Mio Gross’, because the first credit line ‘{BBBL,BBBN}→{AAAZ, AAAL} USD100Mio Gross’ includes the 75mio drawdown on the second. Put another way, if more than 25mio were allowed to trade on credit line (3), this would exceed the limit specified by credit line (1). The design of the system does not allow credit limits to be exceeded-so, among a plurality of lines involved in a trade, it is always the one with the smallest remaining credit that is controlling. It should be noted that credit lines are replenished/reset at regular intervals, such as at 5 PM each day such that trades on the credit lines for that trading day are removed for the next trading day.

For the drawdowns described above to occur, AAA must extend credit back to BBB. For example, the credit lines from AAA could be:

{AAAL,AAAZ}→{BBBL,BBBN} Infinite Gross (4)

More complex examples may include credit lines (5)-(8) (which would mean the 75Mio drawdown in the example above wouldn't be possible):

AAAL→BBBN 20Mio Gross (5)

AAAL→BBBL 40Mio Gross (6)

AAAZ→BBBN 35Mio Gross (7)

AAAZ→BBBL 35Mio Gross (8)

If AAA entered all credit lines 4-8, credit line (4) may be ignored with respect to any credit-related computations because it is never controlling. Credit lines 5-8 completely cover all variations of credit line 4 and all have smaller limits than credit line 4.

### Multiple Credit Codes in Market Data

Instead of sending out market data updates containing individual orders in the limit order book (as would be the case for ‘market-by-order’), the ETV 110 instead performs an aggregation operation over the order books 122 to provide market data updates that show only the total quantity and price at each level in the book. This is illustrated further below:

### Bid Book in Matching Engine

Price Temporal List of Orders (each appearing as [Credit Code, Quantity])
1.23 [AAAA,5mio] [BBBB,1mio] [CCCC,2mio]
1.22 [BBBB,10mio] [DDDD,1mio]
1.21 [BBBB,2mio] [AAAA,2mio]

### Bid Book as Market-By-Price in Unscreened Market Data Update

Price Total Quantity at Price Level
1.23 8Mio (since [AAAA,5mio]+ [BBBB,1mio]+ [CCCC,2mio]=8Mio)
1.22 11Mio (since [BBBB,10mio]+ [DDDD,1mio]=11Mio)
1.21 4Mio (since [BBBB,2mio]+ [AAAA,2mio])

We now provide a worked example showing the problem of determining whether quantity is duplicated (or not) across distinct credit codes' screened updates. To illustrate this problem imagine a participant that has a plurality of credit codes and is receiving screened prices for each of them when that screening is performed on the following book:

### Bid Book in Matching Engine

Price Temporal List of Orders (each appearing as [Credit Code, Quantity])
2.01 [AAAA,1mio] [BBBB,1mio] [CCCC,1mio]

If the participant's (public interbank) credit codes are YYYY and ZZZZ, and that only the following credit lines exist (call this the ‘first credit universe’):
ZZZZ→AAAA infinite Gross
AAAA→ZZZZ infinite Gross
YYYY→BBBB infinite Gross
BBBB→YYYY infinite Gross

The three market data updates for this participant will be as follows:
Bid Book as Market-By-Price in Market Data Update for ZZZZ
Price Total Quantity at Price Level
   1Mio (counterparties without bilateral credit stricken out
2.01 [AAAA,1mio] [symbol] )

### Bid Book as Market-By-Price in Market Data Update for YYYY

Price Total Quantity at Price Level
   1Mio (counterparties without bilateral credit stricken out
2.01 [symbol] [BBBB,1mio] [symbol] )

### Bid Book as Market-By-Price in Unscreened Market Data Update

Price Total Quantity at Price Level
2.01 3Mio (since [AAAA,1mio]+ [BBBB,1mio]+[CCCC,1mio]=3mio)

Note that these market data updates are indistinguishable from the updates that would arise if the credit lines were instead (call this the ‘second credit universe’):
ZZZZ→AAAA infinite Gross
AAAA→ZZZZ infinite Gross
YYYY→AAAA 5Mio Gross
AAAA→YYYY 5Mio Gross

The computation in terms of which orders are removed for screened update for YYYY is different in the second credit universe—AAAA is retained instead of BBBB—but the output of that computation in the market data is the same: 1mio at the 2.01 price level.

Because two distinct credit universes lead to the same market data updates, the participant is left to guess how to act upon those market data updates when sending liquidity-taking orders. In the first credit universe, if the participant wishes to sell at price 2.01 the ‘right’ action is to send two distinct orders: one for 1mio on their code ZZZZ and one for 1mio on their code YYYY. In this first credit universe both will fill.

In the second credit universe the ‘right’ action is to send only one order. If the participant sends two orders only one will fill. This is because the liquidity providing order AAAA is ‘duplicated’ across the credit screened update for ZZZZ and YYYY. The participant has no way to tell this. And even if the participant could tell the AAAA order was duplicated (e.g., because the market data was distributed as market-by-order, and not market-by-price), the participant would still disadvantageously have to choose which credit code to send the order on: YYYY or ZZZZ.

Among other reasons, for the purposes of maximizing credit utilization for all participants across the entire credit universe, the ETV 110 may select which among YYYY and ZZZZ is allowed to match with AAAA. In the second credit universe, the credit between ZZZZ and AAAA is (bilaterally) infinite so the ETV 110 may choose to match ZZZZ with AAAA on this basis. The alternative, matching YYYY with AAAA will draw down an already small bilateral line of 5mio to 4mio, potentially limiting future trades between that pair of codes. Note that only the ETV 110 itself can ‘see’ bilateral credit. Participants with interbank credit codes are only able to see the (unilateral) credit they have extended to others, and not what others have extended back to them. No participant therefore can determine which of their codes best utilizes credit for the venue, or even for themselves.

Another, more complex example shows a ‘knock-on’ effect. In this example consider a third credit universe:
YYYY→ {AAAA,BBBB} 1Mio Gross (YYYY is extending in aggregate to AAAA & BBBB)
AAAA→YYYY infinite gross
BBBB→YYYY infinite gross
ZZZZ→BBBB infinite gross
BBBB→ZZZZ infinite gross

Further in this example, the ask book in the matching engine 120 may include:
Price Temporal List of Orders (each appearing as [Credit Code, Quantity])
4.21 [BBBB,1mio]
4.22 [AAAA,1mio]

Further still, imagine the liquidity-taking participant wanting to buy 2mio and having the plurality of credit codes YYYY and ZZZZ. To do this, the participant must send a buy order on ZZZZ for 1mio at 4.21 followed by a buy order on YYYY for 1mio at 4.22. There is no way that the participant can infer this ‘right’ sequence of orders and codes from the market data updates s/he receives on those two credit codes:
Ask Book as Market-By-Price in Market Data Update for YYYY
Price Temporal List of Orders (each appearing as [Credit Code, Quantity])
   1Mio (this order [BBBB,1mio] draws down the ‘YYYY→{AAAA,BBBB} 1Mio Gross’ to zero; zero remaining credit
4.21 here ‘knocks-on’ to next level in book)
   0Mio (no credit left on ‘YYYY→{AAAA,BBBB} 1Mio Gross’ line for
4.22 [AAAA,1mio] because of drawdown above at price 4.21 on AAAA)

Put another way, the YYYY order can't match with both AAAA and BBBB in the book. It can only match for 1mio due to the size of its line. Therefore, in computing its screened book, it just matches with the order that has highest priority. In this case, detrimentally to the aggregate of the YYYY&ZZZZ codes, it must match with the BBBB at the 4.21 price level because that has higher priority (has a lower price) than the AAAA at 4.22. Thus the screened book for YYYY is as shown above.

Consider now the screened ask book for code ZZZZ below:
Ask Book as Market-By-Price in Market Data Update for ZZZZ
Price Temporal List of Orders (each appearing as [Credit Code, Quantity])
4.21 1Mio (infinite credit between ZZZZ and BBBB for [BBBB,1mio])
4.22 0Mio (no credit between ZZZZ and AAAA for [AAAA,1mio])

Given the two screened market data updates above, the best a participant could hope to be able to send off-the-bat, is two buy orders at 4.21 both for 1mio. If the first order among those two was sent on the YYYY credit code then absent any change to the third credit universe, the AAAA order at 4.22 is lost forever to the liquidity-taking participant. That is because the YYYY order will match with AAAA at 4.21 and draw down the YYYY→{AAAA,BBBB} line to zero.

What would be preferable is for the participant to be able to subscribe to a single screened update: the aggregate of XXXX & YYYY. In this way (through a depth first search, and/or other techniques) the venue can provide to the participant a more accurate screened book:

Ask Book as Market-By-Price in Market Data Update for aggregate of YYYY&ZZZZ
Price Temporal List of Orders (each appearing as [Credit Code, Quantity])
   1Mio (chose ZZZZ for the BBBB order here, due to infinite credit: [BBBB,1mio], might not even need depth-first-search due to
4.21 infinite credit on smallest line)
   1Mio (choose YYYYY for AAAA here since credit exists
   [AAAA,a1mio], might not even need DFS as only bilateral relationship
4.22 in universe involving AAAA)

When the participant sends orders, they also have to send on the aggregate of YYYY & ZZZZ and let the venue's credit checking function similarly determine the right sequence of orders on YYYY & ZZZZ that gets them best-ex and/or utilizes credit efficiently.

### Private Credit Codes

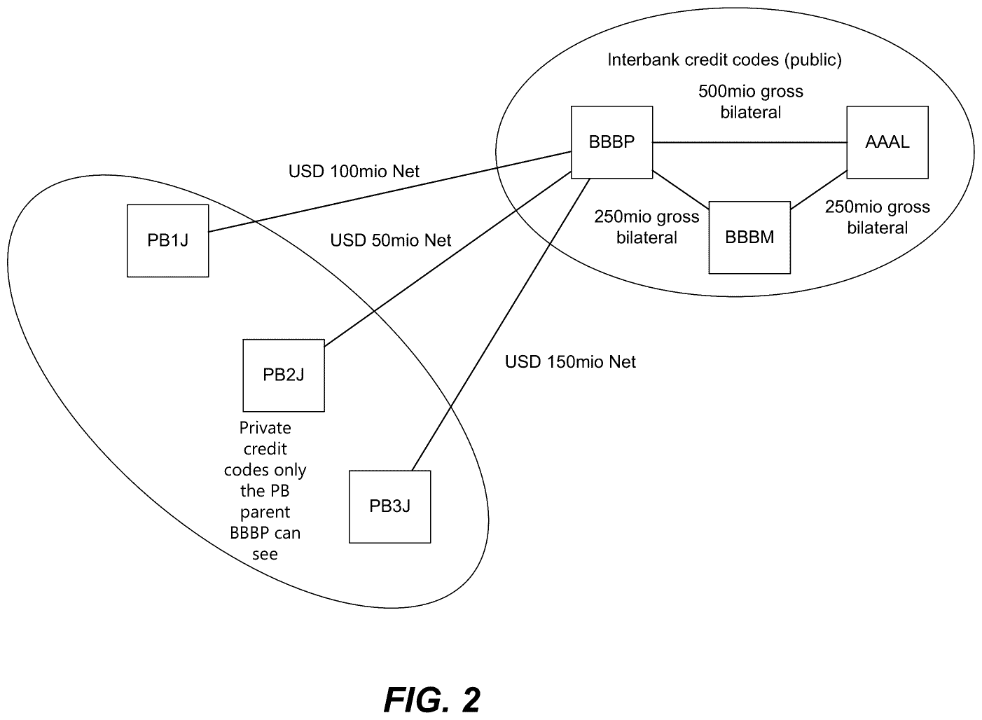

The foregoing issues may be further compounded by participants with private credit codes. FIG. 2 illustrates a schematic example of participants with private credit codes through broker entities. Unlike (interbank) credit codes, private credit codes are not published.

Certain participants use banks (such as AAA or BBB in prior examples) that sponsor them to trade on the ETV 110. These participants will be referred to as PB clients, or simply PBs, and the banks that sponsor them will be referred to as PB parents. A PB client may have multiple PB parents. Each PB parent will have and use its own interbank credit. A PB client and PB parent combination may therefore have a respective credit code. For example, a PB client (“PBC”) may use multiple PB parents, AAA and BBB. When PBC trades with AAA's credit, PBC will use the credit code PBCA. When PBC trades with BBB's credit, PBC will use the credit code PBCB. Each of those banks attaches their PB clients to an interbank credit code (it could be to one of their existing codes such as BBBL, or it could be a special purpose Prime brokerage credit code such as BBBP).

In the interbank market, all the trades occur exclusively between the banks. Thus, if a PB client executes a trade with a counterparty using the credit code PBCA, the counterparty only sees that the trade occurred with the PB parent (AAA) associated with PBCA. PB parents can, and generally do, place limits on each of their respective PB client codes.

As illustrated in FIG. 2, three PB clients are shown, all with BBB as their Prime Broker. Whenever any of those three PB clients trade, it appears to the interbank counterparty they did a trade (only) with BBBP—the BBB Prime Brokerage code. In the case of its PB clients, BBB has imposed a limit on each of them.

In particular, a first PB client may trade using the credit code PB1J (the PB client PB1 with bank BBB that uses credit code BBBP for trades with PB client PB1J). This trade appears to the counterparty in the trade as if the trade occurred with BBBP. Bank BBB, using credit code BBBP, has imposed a limit of 100 million USD net to PB1. A second PB client may trade using the credit code PB2J (the PB client PB2 with bank BBB that uses credit code BBBP for trades with PB client PB2J). This trade appears to the counterparty in the trade as if the trade occurred with BBBP. Bank BBB, using credit code BBBP, has imposed a limit of 50 million USD net to PB2. A third PB client may trade using the credit code PB3J (the PB client PB3 with bank BBB that uses credit code BBBP for trades with PB client PB3J). This trade appears to the counterparty in the trade as if the trade occurred with BBBP. Bank BBB, using credit code BBBP, has imposed a limit of 150 million USD net to PB2. Each of the PB client credit codes (PB1J, PB2J, PB3J) are private (not public) since only the PB parent (BBB in this example) are able to see. As previously noted, trades with the PB client are visible to the counterparty only as BBBP. With respect to interbank credit codes, which are public, in the illustrated examples, BBBP and AAAL has extended 500mio gross bilateral credit, BBBP and BBBM has 250mio gross bilateral credit, and BBBM and AAAL has 250mio gross bilateral credit. It should be noted that BBBP may (and typically does) have hundreds of other PB clients each with their own limits and private credit codes, even though only three are shown. Furthermore, each of the BBBM and AAAL may be associated with respective PB clients, each with their own limits and private credit codes. Furthermore, although only three interbank public credit codes are shown, there are typically thousands of such public credit codes.

When PB1J trades with AAAL, the PB1J-BBBP credit line gets drawn down, but in the interbank market that causes BBBP to trade with AAAL, and that bilateral line is also drawn down. Further complications can arise when a PB client such as PB1 has multiple credit codes such as PB1J, PB1N and PB1B. Instead of trading as three distinct interbank participants (one for each of their PBs),it may be advantageous to view trades of the single entity PB1, making interface with the ETV 110 more frictionless, but the foregoing credit code system makes it difficult to do so.

On an ETV, PB1 may receive three distinct credit screened price update for each instrument: one for PB1J, one for PB1N, and one for PB1B. To the extent their distinct PBs have credit to the same counterparties, they see duplicate quantity in their market data updates. They have to guess what might be duplicate, can't account for knock-on effects in their sent order sequence, and must make guesses as to which orders to send on which credit codes. The latency floor mechanism on ETV 110 (as further described in U.S. Pat. No. 10,325,317B2 entitled ‘Ideal Latency Floor’) further penalizes PB1 and other PB clients having multiple credit codes for sending multiple such orders.

The ETV 110 may mitigate these problems by creating a single synthetic aggregate credit code that merges their distinct PB's codes. For example, the ETV 110 may generate a credit code PB1Z that merges PB1J, PB1N, and PB1B. When PB1 sends orders on PB1Z, the ETV 110 itself may determine, based on best execution (referred to herein as “best-ex”), and efficiency of credit utilization how to split the single synthetic code (PB1Z) into the actual plurality of PB codes (PB1J, PB1N, and PB1B) and sequence of orders thereon to achieve multiple objective optimization in terms of best-ex and credit utilization.

### Depth First Search and Search Space Reduction to Handle Multiple Credit Codes

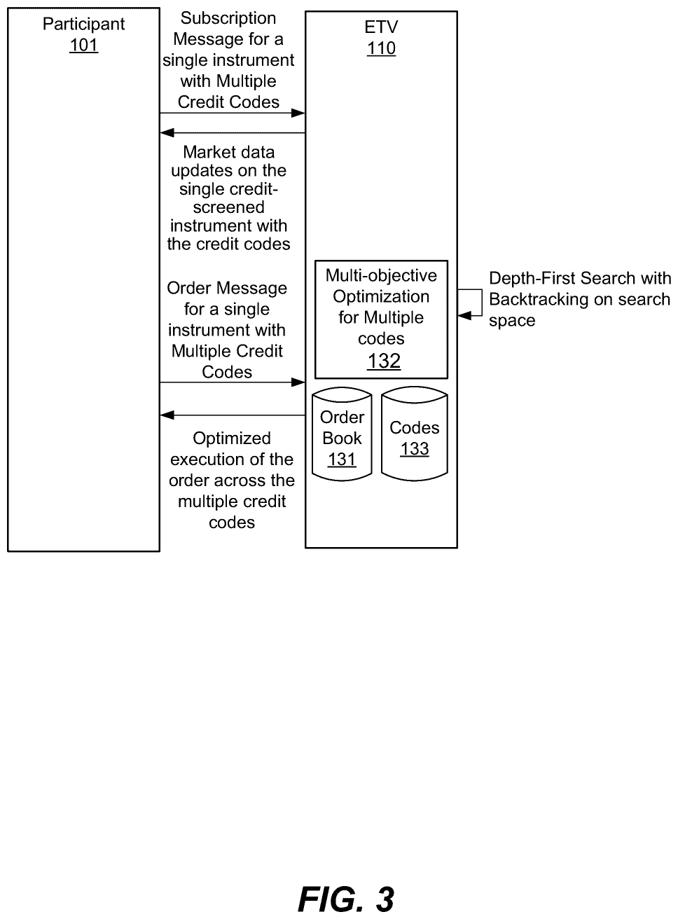

To address the foregoing issues with credit codes and other issues, the ETV 110 may perform multi-objective optimization. In particular, the ETV 110 may use depth-first search with backtracking on the search space that includes permutations of credit codes (including parent/child codes for PB clients and their respective parents) and associated credit lines of the credit codes. For example, FIG. 3 illustrates a schematic of an ETV 110 that performs multi-objective optimization through deep-first search with backtracking and search space reduction. The optimized objectives may include best price and maximized credit line utilization.

As illustrated, a participant 101 may (i) initiate a subscription to a (single) credit-screened market data instrument using a plurality of credit codes, and (ii) send a (single) order message containing a plurality of credit codes in which some combination thereof will be used in a credit-check during a match. Responsive to receiving such a subscription the ETV 110 may, whenever there is a market data update that is to be published, compute the credit-screened market for that instrument as if a contiguous sequence of hypothetical (buy and sell) taker orders having the appropriate combination of sizes and credit codes (chosen from those specified in the subscription) to obtain a best price for the participant 101 for each executable quantity in the (e.g., market-by-price) update.

### Computing the Optimal Sequence of Sub-Orders.

In some examples, the ETV 110 may use DFS with backtracking to generate contiguous sequences of orders chosen from the plurality of credit codes specified on the taker order sent by a participant 101. In some of these examples, the sizes of the orders generated may be based on the lot size of the instrument (e.g., 1mio of base currency). Alternatively, the sizes of the orders may be based on scavenging residuals across the plurality of credit codes in which the sizes of the orders may be different than the lot size of the instrument. For instance, the sizes of the orders may be one tenth or other portion of the lot size of the instrument.

Because the search space may be large, the ETV 110 may reduce the search space to improve computational efficiency. For example, the ETV 110 may impose various bounds to reduce the search space, and consequently the computational effort of its DFS exploration. In a particular example of such bounds, the ETV 110 may generate a ‘template’ to guide the DFS using the existence (but not necessarily magnitude) of credit between each order in the book and each of the credit codes. This template may consider only a portion of the book down to limit price specified on the taker order, and ignore orders in the book with which none of the credit codes have bilateral credit. In an embodiment, an example of such a template involving three credit codes (A, B and C) may be encoded as a string, such as:
“A|AB|AC|A|BC|ABC|C”

In the above string template (also referred to herein as a “DFS string template”) the pipes “|” demarcate decision points in the DFS—what appears between the pipes are the possible choices of credit codes. For the first order in the permutation the only choice is credit code A because no other credit code exists in this position. For the second order in the permutation the choices are A or B. For the third order in the permutation the choices are A or C. For the fourth the choice is only A. And so on. The size of these orders might be chosen to be 1mio, and the lot size of orders on the ETV 110 might also be 1mio, though other templates where lot sizes and order size differ may also be generated.

In the above example there are seven orders in each permutation, but the template has reduced the search space from (at least) 3⁷ permutations to only 1*2*2*1*2*3*1 permutations. When the chosen size of the orders are ‘small’, or lot size/orders in the book are ‘big’, or limit price is deep in the order book, or taker order is big, and so on, additional techniques may also be required to reduce the search space, so the operations of credit screening and credit checking may both exhibit adequate performance. Specifically, when the size of the orders are smaller than the lot size, the search may be reduced by considering only combinations (and not permutations) of orders in a slot. For instance, if the lot size is 1mio and the order size is 250 k then ABAB as a sequence against a 1mio maker order is equivalent to AABB, so the search space need not visit both permutations. Indeed all relevant permutations may be visited instead by performing a lexicographical sort on the credit codes in the slot for the maker order, and varying the plurality of each, so AAAA, AAAB, AABB, ABBB, BBBB would be the totality of those permutations that needed to be visited for that order in this example. Other techniques for reducing the search space also exist.

In some examples, the ETV 110 may reduce, or seek to further reduce, the search space by enabling early termination of the DFS by computing a benchmark price. The benchmark price may be computed by assuming all orders in the book with which there is a credit relationship can actually match, and computing the average price down to the quantity of the taker order as the order book is walked from best-to-worst price. In a more sophisticated embodiment this may also include computing that price while respecting an overarching limit (e.g., that imposed by a PB parent) on each credit code (so not allowing further matches on that credit code after that limit is reached). After the calculation of this benchmark price, the DFS may terminate early once any permutation of orders meeting the benchmark price (or coming within some tolerance of it set by the venue operator) is achieved.

### Preferences Over Credit Codes

In some examples, participants may specify in an administration tool provided by the ETV 110, a preference over credit codes such as to: attempt to divide credit evenly/balance it among credit codes, prefer one credit code over others or rank those credit codes on a per instrument basis, and so on. In this case, the ETV 110 may substantially respect these preferences by choosing (or prioritizing) at each decision point in the DFS the appropriate credit code, or encoding the preference into the search string template. For example, in the string “A|AB|AC”, at each decision point A is preferred over every other credit code by virtue of it appearing first in each slot. In A|BA|CA however, A is least preferred and will be visited later by the DFS by appearing last in each slot.

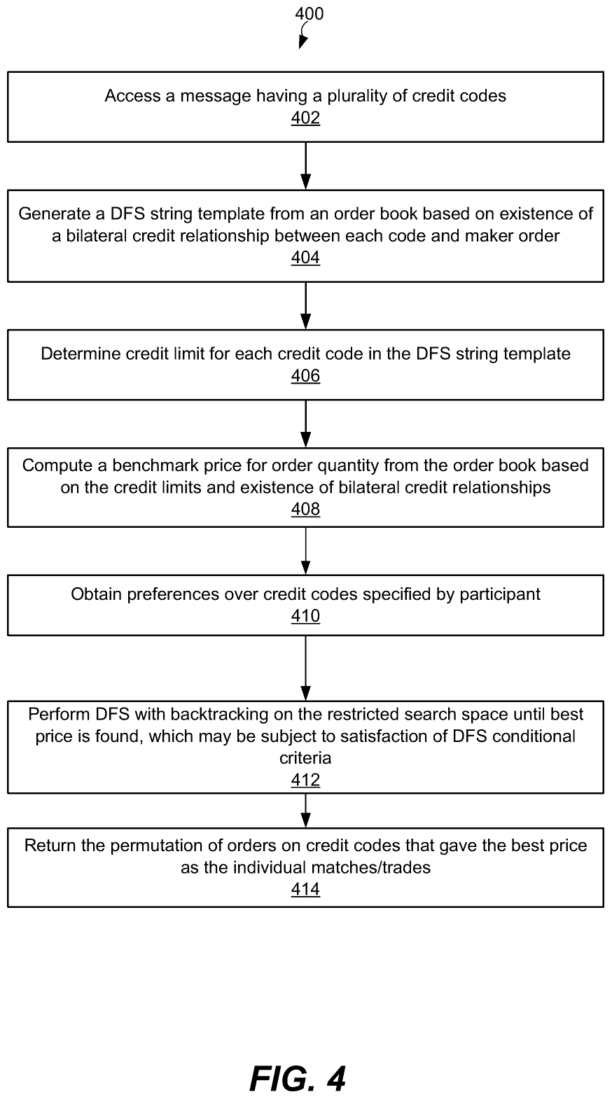

FIG. 4 illustrates an example of a method 400 for multi-objective optimization through deep-first search with backtracking and search space reduction for checking a plurality of credit codes.

At 402, the method 400 may include accessing a message having a plurality of credit codes. The message may originate from a participant 101 and encode an order for a particular instrument traded on the ETV 110. The order may define a limit price, a quantity, and/or other order parameters. Each of the credit codes may identify the participant 101 who is a counterparty to a trade.

At 404, the method 400 may include generating a DFS string template based on an order book and existence of a bilateral credit relationship between each code and maker order. At 406, the method 400 may include determining a credit limit for each credit code. The credit limit is based on credit lines extended by counterparties.

At 408, the method 400 may include computing a benchmark price for order quantity from the order book based on the credit limits and existence of bilateral credit relationships, in which each bilateral credit relationships is based on credit lines extended by counterparties to one another.

At 410, the method 400 may include obtaining preferences over credit codes specified by a participant. At 412, the method 400 may include performing DFS with backtracking and restricted search space until best price is found. Performing DFS may be based on the benchmark price, credit limits, DFS string template, book subset to which string template pertains, credit code preferences with backtracking, and checking each order dynamically against credit system and restricting search space. Each match may be rolled back in the credit system with each backtracking step until the best price for the order is found.

In some examples, performing DFS at 412 may be subject to satisfaction of DFS conditions. For example, in an embodiment, DFS is performed only if the following conditions are true:
Condition (1) there is a credit line exhaustion for one of the taker codes when processing that taker code against maker orders down to the relevant depth in the book;
Condition (2) more maker orders pertaining to that exhausted credit line remain in the book down to the relevant depth beyond where the line was exhausted; and
Condition (3) a distinct taker credit code can instead match with the maker orders that contributed to the exhaustion of that credit line thus freeing up the line to instead include maker orders deeper in the book.

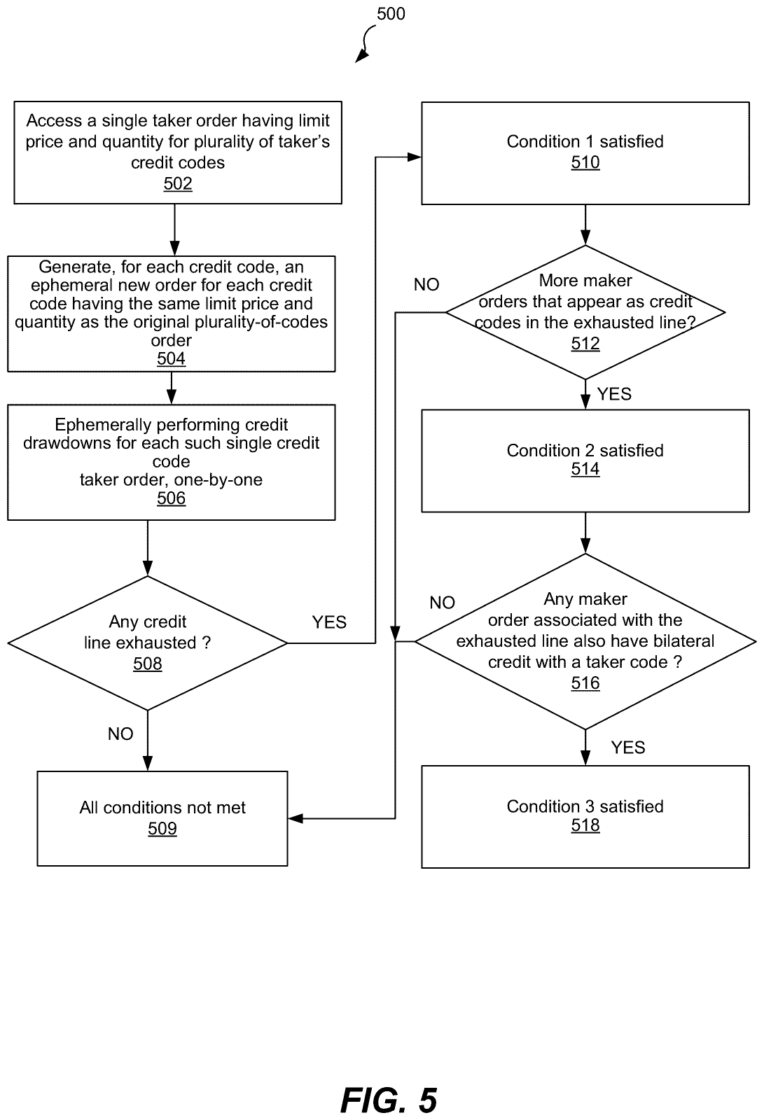

An example of evaluation of whether the DFS conditions are met is illustrated in FIG. 5.

At 414, the method 400 may include returning the permutations of orders on credit codes that gave the best price as the individual matches/trades.

DFS Interaction with Credit Engine.

In an embodiment the DFS may pass the order pair (maker order and taker order on specific credit code) to the credit engine as the permutation is being generated from the template, rather than at the end of the search branch after the entire permutation has been generated. Advantageously, this dynamic use of the credit engine may allow reduction of the search space if orders appearing early in the permutation cause credit to be exhausted on orders from the same maker that would otherwise appear later in the permutation. Also advantageously, this may reduce the total number of credit checks that need to be performed. In the case of the following string template (also referred to as “DFS string template”), for instance, “A|B|ABC”, by allowing the DFS dynamic interaction with the credit engine the first order need only be credit checked once; the second order only once too; and the third order up to three times for a total of 5 credit checks. If, however, credit checking occurs only after the complete generation of all permutations a total of nine (3×3) credit checks are required. Efficient implementation of this dynamic credit checking during DFS may require that the credit system support “rollback” or “undo” operation on any given match.

In some examples, the search templates may not include sufficient information for credit checking, or even when the order size and lot size on the venue differs compute the sequences. In these examples, the search function is provided with the corresponding subset of the book from which the template was computed. This subset of the book may include the maker orders including their limit prices, sizes and counterparties that submitted them. The combination of the search string template and this subset of the book allows the dynamic credit checking to occur; without it there is insufficient information inside the scope of the search function to perform this dynamic per order checking with rollback.

In the case of credit checking, an order has a fixed size and fixed limit price, which is not precisely the case in credit-screening for market data. In the case where credit-screening is used to generate market-by-price market data, a cutoff at a certain depth of book may be used (e.g, 10-levels each side of book). Alternatively, the computation for credit-screening may proceed as it would for credit checking, but instead with (hypothetical) a taker order having infinite size and no limit price. A further consideration for credit-screening is that it may need to be parallelized for sufficient performance, and under such a scheme the credit drawdowns performed during credit-screening will not block or otherwise interfere with actual credit checking of orders sent to the venue. Systems and techniques for this parallelization are described in U.S. patent application Ser. No. 17/886,587, filed Aug. 12, 2022, entitled “Deterministic Credit System,” which is incorporated by reference in its entirety herein for all purposes. Systems and techniques that can facilitate the sending of a plurality of credit codes in a single order, and have the credit engine component of the venue perform much of what would conventionally be performed instead by a matching engine component are described in U.S. patent application Ser. No. 17/886,676, filed Aug. 12, 2022, entitled “Pipelined Credit Checking”, which is incorporated by reference in its entirety herein for all purposes.

FIG. 5 illustrates an example of a method 500 for evaluating whether DFS conditions have been met, such as the three Conditions (1)-(3) described above.

At 502, the method 500 may include accessing a single taker order having limit price and quantity for plurality of taker's credit codes.

At 504, the method 500 may include generating, for each credit code, an ephemeral new order for each credit code having the same limit price and quantity as the original plurality-of-codes order. The term “ephemeral” is intended to mean virtual, or not actual, for the purpose of processing. Thus, an ephemeral new order is an order that is virtually or temporarily made for the purpose of processing to determine whether DFS conditions have been met.

At 506, the method 500 may include ephemerally performing credit drawdowns for each such single credit code taker order, one-by-one. Credit drawdowns on actual credit lines are not actually performed, but rather hypothetically performed for the purpose of processing to determine whether DFS conditions have been met.

At 508, the method 500 may include determining whether a credit line was exhausted at 506. If not, then all conditions have not been met at 509. If a credit line was exhausted, at 510, Condition 1 is satisfied and the maker credit codes associated with that exhausted line are noted.

At 512, as the taker order is further walked down the book to the relevant depth, the method 500 may determine whether more maker orders are encountered that appear as credit codes in the exhausted line. If not, then all conditions have not been met at 509. If more maker orders are encountered that appear as credit codes in the exhausted line, at 514, Condition 2 is satisfied and these orders are also noted.

At 516, the method 500 may include determining whether one or more of the maker orders associated with the exhausted line (prior to its exhaustion) also have bilateral credit with a taker code distinct from that in this specific ephemeral taker order. If not, then all conditions have not been met at 509. If one or more of the maker orders associated with the exhausted line (prior to its exhaustion) also have bilateral credit with a taker code, at 518, Condition 3 is satisfied.

To illustrate conditional DFS, the following example book and credit lines will be described:
Ask Book in Matching Engine
Price Temporal List of Orders (each appearing as [Credit Code, Quantity])
4.21 [BBBB,1mio]
4.22 [AAAA,1mio]
With credit universe:
YYYY→{AAAA, BBBB} 1Mio Gross (YYYY is extending in aggregate to AAAA & BBBB)
AAAA→YYYY infinite gross
BBBB>YYYY infinite gross
ZZZZ→BBBB infinite gross
BBBB→ZZZZ infinite gross

Suppose that the participant has sent a maker order to sell 2Mio with the credit codes YYYY & ZZZZ as taker. The three conditions may be evaluated as follows.

First, suppose the sell order is for 2Mio just on YYYY. This results in a match on BBBB at 4.21 for 1mio. But the credit line pertaining to that match is now exhausted: Condition 1 is met. Now a match between YYYY and AAAA down to the relevant depth (2mio into the book) is attempted, but cannot be made because the line YYYY→{AAAA,BBBB} was previously exhausted and this maker order also pertains to that same line: Condition 2 is met. A determination of whether the maker orders that exhausted credit on this line can trade with the other taker code ZZZZ is made. They can, because ZZZZ and BBBB have bilateral credit: Condition 3 is met. Since all three conditions are met, a DFS search to compute the best price for the 2mio trade is then performed. The output of the DFS search is a sequence of orders in which each order is associated with exactly one of the taker codes (YYYY or ZZZZ in the foregoing example).

These conditions also advantageously constrain the DFS search. Conceptually, the system attempts to capture orders deeper in the book with a credit code and credit line that has been exhausted, but substituting what it would have otherwise matched with earlier in the book with a distinct credit code. In the example, the naïve match YYYY & BBBB is substituted instead with match ZZZZ & BBBB, so credit is ‘freed up’ to allow YYYY & AAAA to match.

As for the relevant depth, if the order is a market order the relevant depth for a given ephemeral market order is the depth until all orders in the book have been considered, or the depth at which the order's quantity would be completely filled had that single code order been sent instead of the plurality-of-codes order. In the case the order is a limit order the relevant depth is the same except it terminates when the depth in the book first exceeds the limit price, or when the order is completely filled had it instead been sent as a single code order (whichever of these two things happen first). The possible substitutions from ‘condition 3’ and freed up credit from ‘condition 2’ following such a substitution naturally inform/constrain our depth first search.

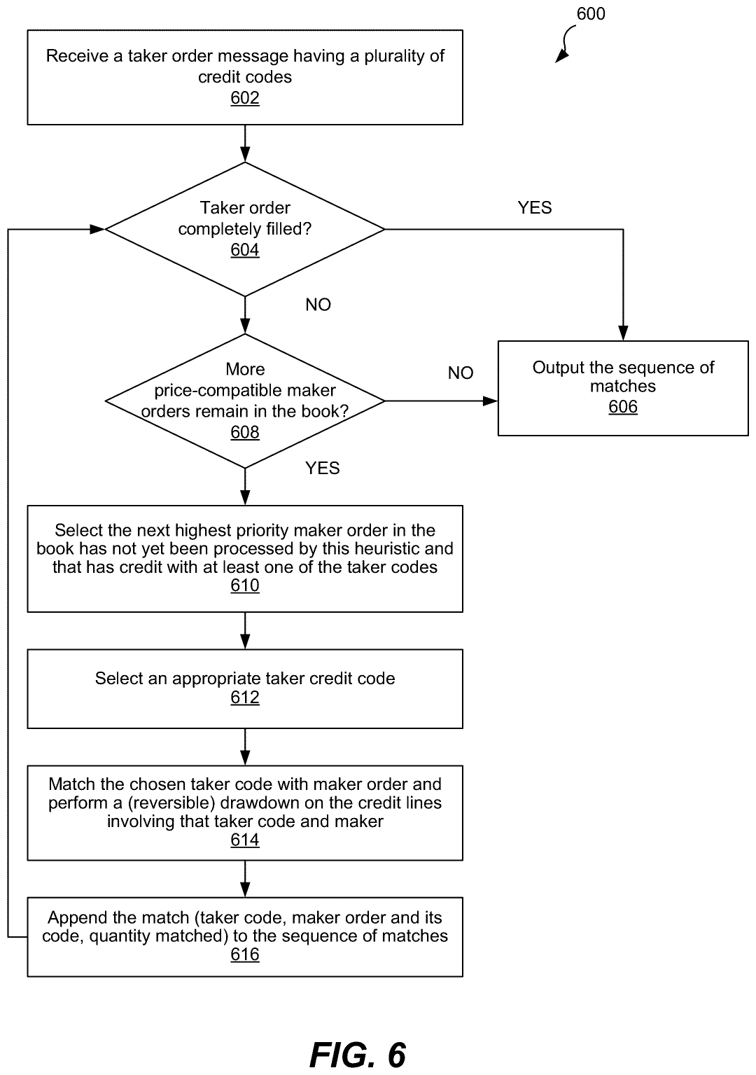

FIG. 6 illustrates an example of a method 600 for generating input sequence for input to a best-ex search function involving a plurality of credit codes;

At 602, the method 600 may include receiving a taker order message comprising a plurality of credit codes. If the submitter of the taker order message included preferences that specifies the preferred order in which to exhaust credit lines specified by the credit codes, the taker order message will include user-defined preferences.

At 604, the method 600 may include determining whether the taker order specified by the taker order message has been fully filled. If the taker order has been fully filled, at 606, the method 600 may including outputting the sequence of matches generated by the method 600.

If the taker order has not been fully filled, at 608, the method 600 may include determining whether there are more price-compatible maker orders remaining in the book. If there are no more price-compatible maker orders remaining in the book, the method 600 may proceed to 606.

If there are additional price-compatible maker orders remaining in the book, at 610, the method may include selecting the next highest priority maker order in the book has not yet been processed by this heuristic and that has credit with at least one of the taker codes.

At 612, the method 600 may include selecting an appropriate taker code. If a preference over the taker codes is specified in the taker order, the most preferred taker code that has credit with the maker is selected. If there are no preferences, a taker code may be chosen at random from all eligible taker codes that exceed a minimum threshold of remaining credit with the maker. Alternatively, the taker code that in expectation has the most credit remaining (based off statistical analysis of historical trading behavior of the maker and taker on the venue for the purpose of prediction) may be chosen, noting this may not necessarily correspond to the line with the most credit remaining on it at this instant in time. Alternatively still, the taker code that is expected to have the most credit remaining after consideration is given to what maker orders are available for it to match with (and with it will drawdown the same line as the instant maker order) deeper in the book down to the taker order's limit price may be chosen. Otherwise, if none of the foregoing are met, then the taker code with the largest remaining credit with that maker may be selected.

At 614, the method 600 may include matching the chosen taker code with maker order and perform a (reversible) drawdown on the credit lines involving that taker code and maker.

At 616, the method 600 may include appending the match (taker code, maker order and its code, quantity matched) to the sequence of matches.

When a participant sends a taker order to the venue containing a plurality of credit codes, and equally when a participant in a single market data subscription to an instrument specifies a plurality of credit codes for that single subscription, a search operation will usually be required over those credit codes to find the right sequence of those codes such that when they are applied to the book, the participant is able to see the best (credit-screened) price for all quantities in it in market data, or is able to obtain ‘best-execution’ (during credit-checking) against it when submitting such a taker order.

Since electronic latency venues usually have stringent performance requirements, ensuring this search operation completes as quickly as possible is desirable. One way to help ensure expeditious completion of such a search operation is to provide an input to it that is already close to (or expected to be close to) the optimal solution it seeks to find. The greedy heuristic described above and in FIG. 6 may be used to provide an initial input to that search function for market data credit-screening and for credit-checking when there is a plurality of credit codes involved.

In the method 700, a taker order is received by the venue containing a plurality of taker codes (equally this may apply to credit-screening: in that case the ‘taker order’ may have infinite size and the worst limit price that appears in the contra-side of the book). Having received such a taker order the venue—as per a conventional matching operation—may walk down the contra-side of the book, one maker order at a time, from best-to-worst price attempting to match each such maker order with the taker order. Again—as per a conventional matching operation—the venue's process of walking down the book terminates when either the taker order is completely-filled or when all the price-compatible maker orders in the book have been processed against the taker order.

It is the plurality of credit codes on that taker order that makes things interesting here with respect to the matching operation, as illustrated in FIG. 6. As each maker order is encountered during the operation's walk down the book, there is potentially a choice of which credit code on the taker order to match the maker order with. When faced with such a choice, in an attempt to ensure credit is not exhausted early in the matching operation (to the detriment of orders that are deeper in the book and due that that early exhaustion might not otherwise be able to match with the taker), the taker code chosen may be the one with the most credit remaining with that maker order. When there is more than a minimum threshold of credit remaining on each of the taker codes eligible to match with that maker, to prevent the absolute largest credit line always receiving fills one of the taker codes among them may be chosen at random. Alternatively, a participant may specific user-defined preferences in their taker order message over the plurality of codes appearing in that message, and in this case the participant's most-preferred code that is eligible (has sufficient credit) to match with the maker order will be used.

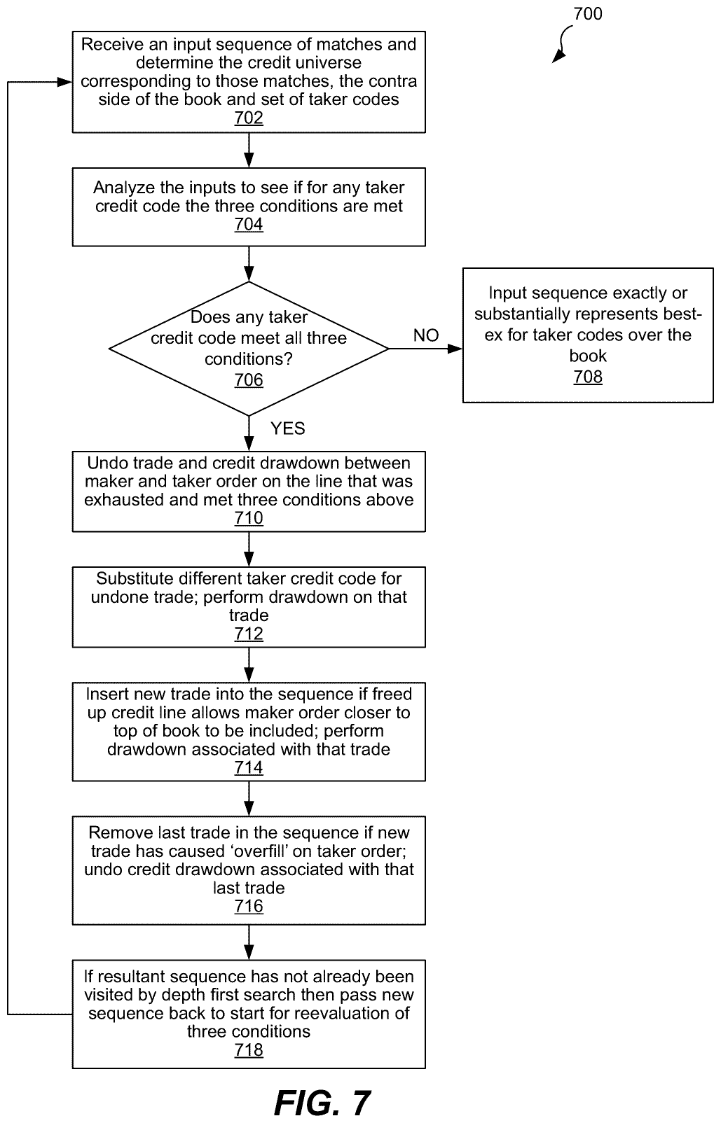

Having performed a match between maker order and taker code, the relevant credit lines are drawn down before proceeding to the next maker order in the walk. This drawdown may be designed to be ‘reversible’ so that if the final sequence of matches output by the heuristic upon its termination is subsequently modified by the search process that sequence is input to, the removal of a match from the sequence ‘restores’ the correct amount of credit to the lines affected by that match. Following the generation of the match (taker code, maker order and quantity between maker and taker), the match is appended to the sequence of such generated by the book walk. Upon completion of the book walk the sequence generated is the heuristic's final output. That output may be fed into a search algorithm for further manipulation towards ‘best-ex’, an example of which is described with respect to FIG. 7.

FIG. 7 illustrates an example of a method 700 for the best-ex search function. At 702, the method 700 may include receiving an input sequence of matches and determining the credit universe corresponding to those matches, the contra side of the book and set of taker codes. Determining the credit universe may include determining the credit lines associated with the credit codes of the sequence of matches. The input sequence may be the sequence generated by the method 600 illustrated in FIG. 6.

At 704, the method 700 may include analyzing the inputs to see if for any taker credit code the three conditions (Conditions (1)-(3)) are met. At 706, the method 700 may include determining whether any taker credit code meet all three conditions.

If none of the taker credit codes meets all three conditions, then at 708, the input sequence exactly or substantially represents best-ex for taker codes over the book and the method 700 may exit.

If any taker credit code does meet all three conditions, at 710, the method 700 may include undoing the trade and credit drawdown between maker and taker order on the line that was exhausted.

At 712, the method 700 may include substituting different taker credit code for undone trade; perform drawdown on that trade. In some instances, 712 may include undoing another trade for that different taker code if its line is also exhausted if the trade being undone is deeper in the book than the new trade from the freed up line described at 714.

At 714, the method 700 may include inserting a new trade into the sequence if freed up credit line allows maker order closer to top of book to be included; perform drawdown associated with that trade

At 716, the method 700 may include removing the last trade in the sequence if the new trade has caused ‘overfill’ on taker order and undoing the credit drawdown associated with that last trade.

At 718, the method 700 may include, if the resultant sequence has not already been visited by DFS, then pass the new sequence back to start for reevaluation of the three conditions.

The search function seeks to obtain the sequence of matches that obtain the best price for the taker given the plurality of credit codes specified in its order (or in its market data subscription). In the most trivial case, all three of the conditions described are not met when the (initial) sequence of matches provided as input are processed against the book. Put another way, there are no substitutions of taker codes in the input sequence that can be made to obtain matches on maker orders closer to the top of the book. This may be a termination condition for the search algorithm.

When the three conditions are met for any credit code, the search function attempts to obtain a match with a maker order nearer the top of the book by substituting a taker code for another where doing so ‘frees up’ otherwise exhausted credit, and allows a maker order closer to the top of the book to be included in the sequence of matches. The process of checking for an exhausted line and attempting a substitution can repeat over-and-over on each new sequence generated by the previous substitution. As such, it may be implemented as a Depth First Search. By providing the method 700 with a near optimal initial input, the expectation is that few iterations and substitutions of codes will be required before that optimal output is found.

### Plurality of Credit Codes on a Maker Order

Various examples described herein illustrated obtaining best-ex for a plurality of credit codes specified on a liquidity-taking order (or likewise in a market data subscription request). It is also possible that a participant may want to specify such a plurality of credit codes on an order that provides liquidity (i.e., an order that is inserted into the limit order book because does not cross the spread and so it is not matched immediately on entry). By providing such a plurality of codes on an order the participant may advantageously enable a more diverse group of takers to match with that order, rather than (say) submitting the same order in duplicate (or triplicate etc)—once for each credit code—and risking an overfill on that order by virtue of it being submitted in duplicate (or triplicate etc). As is the case for taker orders, a participant may optionally specify a preference over the plurality of codes specified in their maker order, which the venue may use in addition or alternatively to any ‘built-in’ criteria (as previously described and, for instance, relating to efficient credit line usage) it implements for ranking such codes.

There may be two cases to consider when a plurality of credit codes are submitted on a maker order: (i) all codes belong to (i.e., are under the control of) the same ultimate parent organization and (ii) the codes span disparate ultimate parent organizations because the participant is a prime brokerage client and they utilize a plurality of distinct prime brokers.

In the first case where all codes belong to the same ultimate parent organization it may be advantageous for the ETV 110 to execute additional trades on behalf of the participant who submitted the maker order. Consider, for instance, a single bank that has separate codes for its London and New York branches. A trader in the New York branch submits a maker order with both the London and New York codes on it. Subsequently a taker matches with that maker order but the venue determines based on the credit universe that taker can only match with the London code (e.g., because the taker has not extended credit to any US-based codes). In this case it may be advantageous for the venue to execute an additional trade between the maker's New York code and its London code. An example of this is provided below:

First, a single maker order to sell 1mio eur/gbp at 1.0000 entered with both of the bank's London (BLDN) and New York codes (BNYK) codes. The trader entering sell order works out of New York branch. Second, a taker (ATKR) that only has bilateral credit with BLDN matches with maker order, buying 1mio eur/gbp at 1.0000. The trade draws down bilateral line(s) involving ATKR and BLDN. Finally, the venue (optionally) executes additional trade between BLDN and BNYK. Specifically, BNYK sells 1mio eur/gbp at 1.0000 to BLDN, who buys. This may also drawdown bilateral lines between BLDN and BNYK.

The end result in this example is that the trader's ‘correct’ credit code ultimately does the deal by way of an intermediate credit code belonging to a different one of the bank's branches. This is further illustrated in the table below:

| | |
|---|---|
| Direction | Credit code |

| of trade | ATKR | BLDN | BNYK |
|---|---|---|---|
| Buys | 1mio eur/gbp at | 1mio eur/gbp at | |
| | 1.0000 | 1.0000 | |
| sells | | 1mio eur/gbp at | 1mio eur/gbp at |
| | | 1.0000 | 1.0000 |

Note that although the example shows intermediation through just a single credit code, depending on the bilateral credit relationships among the ultimate parent organization's codes, intermediation may need to occur through a plurality of codes. It should be noted that the ultimate parent organization could be BBB. It might have branch in India, in London and in NY. It might be the case the India branch cannot trade with the NY branch due to regulatory constraints. In that case the Indian branch might ‘intermediate’ as follows: India→London→NY, which would constitute intermediation through a plurality of the ultimate parent organization's codes. The bilateral credit relationships BBB get to set between their codes would specify that India code couldn't trade with the New York code: no credit lines would be extended between those branches by BBB.

In the second case where all codes on the maker do not belong to the same ultimate parent organization it may be disadvantageous to ‘intermediate’ the trade through a third code as was shown in the example above. Such intermediation may be disadvantageous as it may impose additional settlement costs on the prime brokers, and additional brokerage charges on the prime brokerage client. Regardless, posting the order on a plurality of credit codes may nevertheless improve the probability of it being filled because doing so may enable a wider range of takers to match with it.

### Effect of Maker Orders Having a Plurality of Credit Codes on Greedy Algorithm and Best-ex Search Procedure

An effect of having a plurality of codes in maker orders is the extra degrees of freedom it leads to in the greedy heuristic for determining a best initial sequence of matches, and in the search algorithm for refining (potentially improving upon) that initial sequence. In both cases the process instead of trying to match a plurality of taker codes against a single maker code is now attempting to obtain best-ex by matching a plurality of maker codes against a plurality of taker codes (potentially) at each time a maker order is visited in the book. Naively, if the taker codes are XXXX, YYYY and ZZZZ, instead of considering just a single maker code AAAA against each of them: AAAA-XXXX, AAAA-YYYY, AAAA-ZZZZ, it may additionally involve (if the additional maker codes are BBBB and CCCC): BBBB-XXXX, BBBB-YYYY and BBBB-ZZZZ as well as CCCC-XXXX, CCCC-YYYY and CCCC-ZZZZ.

The criteria for matching taker code with maker code remain unchanged. For the heuristic the ETV 110 may select the pair of taker code and maker code that has the most credit remaining on its controlling line, from the set of pairs of taker and maker codes. A taker code can still only match with a maker code if there is sufficient bilateral credit. To perform a substitution to ‘free up’ credit when credit is exhausted between a maker and taker code yet unmatched maker orders pertaining to this line remain in the book that could lead to a price improvement, besides substituting taker codes, maker codes may also be substituted.

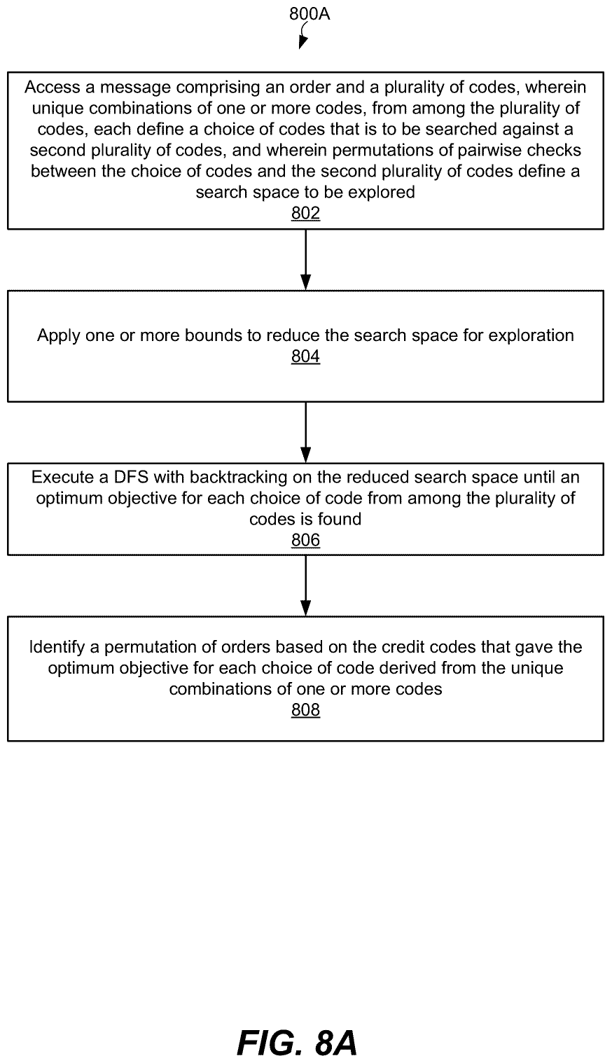

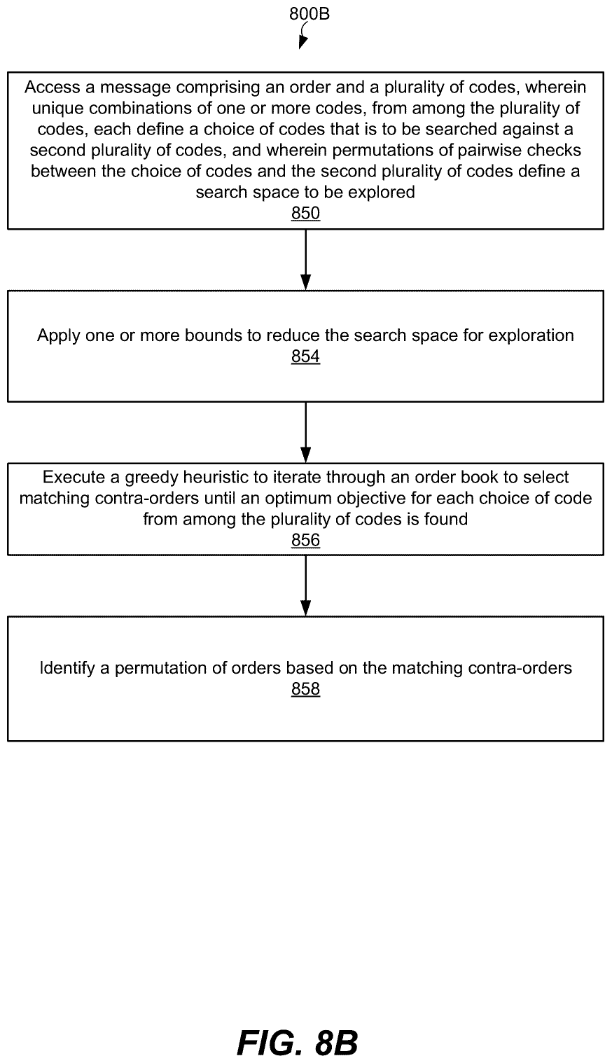

FIG. 8A illustrates an example of a method 800A for multi-objective optimization through deep-first search with backtracking and search space reduction.

At 802, the method 800A may include accessing a message comprising an order and a plurality of codes, wherein unique combinations of one or more codes, from among the plurality of codes, each define a choice of codes that is to be searched against a second plurality of codes, and wherein permutations of pairwise checks between the choice of codes and the second plurality of codes define a search space to be explored. At 804, the method 800A may include applying one or more bounds to reduce the search space for exploration. At 806, the method 800A may include performing DFS with backtracking on the reduced search space until an optimum objective for each choice of code from among the plurality of codes is found. At 808, the method 800A may include identifying a permutation of orders based on the credit codes that gave the optimum objective for each choice of code derived from the unique combinations of one or more codes.

FIG. 8B illustrates an example of a method 800B for multi-objective optimization through deep-first search with backtracking and search space reduction.

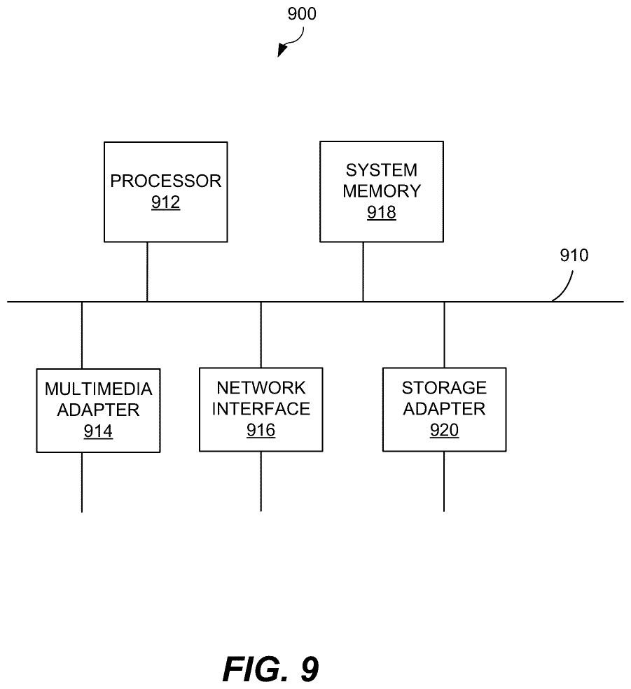

At 852, the method 800B may include accessing a message comprising an order and a plurality of codes, wherein unique combinations of one or more codes, from among the plurality of codes, each define a choice of codes that is to be searched against a second plurality of codes, and wherein permutations of pairwise checks between the choice of codes and the second plurality of codes define a search space to be explored. At 854, the method 800B may include applying one or more bounds to reduce the search space for exploration. At 856, the method 800B may include executing a greedy heuristic to iterate through an order book to select matching contra-orders until an optimum objective for each choice of code from among the plurality of codes is found. An example of the greedy heuristic is illustrated by the method 600 of FIG. 6. At 858, the method 800B may include identifying a permutation of orders based on the contra-orders. In some examples, if the identified permutation of orders is determined to be non-optimal, the method 800B may execute DFS, such as described at 806 and 808 of FIG. 8A.FIG. 9 illustrates an example of a computer system 900 that may be implemented by the computer system illustrated in FIGS. 1 and 3. The computer system 900 may include, among other things, an interconnect 910, a processor 912, a multimedia adapter 914, a network interface 916, a system memory 918, and a storage adapter 920.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 910 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 910 may allow data communication between the processor 912 and system memory 918, which may include read-only memory (ROM) or flash memory (neither shown), random-access memory (RAM), and/or other non-transitory computer readable media (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 912 may control operations of the computer system 900. In some examples, the processor 912 may do so by executing instructions such as software or firmware stored in system memory 918 or other data via the storage adapter 920. In some examples, the processor 912 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computer system 900 with an ability to communicate with a variety of remote devices over a network. The network interface 916 may include, for example, an Ethernet adapter, a Fibre Channel adapter, and/or other wired- or wireless-enabled adapter. The network interface 916 may provide a direct or indirect connection from one network element to another, and facilitate communication and between various network elements.

The storage adapter 920 may connect to a standard computer readable medium for storage and/or retrieval of information, such as a fixed disk drive (internal or external).

Other devices, components, elements, or subsystems (not illustrated) may be connected in a similar manner to the interconnect 910 or via a network. The network may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

The devices and subsystems can be interconnected in different ways from that shown in FIG. 9. Instructions to implement various examples and implementations described herein may be stored in computer-readable storage media such as one or more of system memory 918 or other storage. Instructions to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

In FIG. 1, as well as in other drawing Figures, different numbers of entities than those depicted may be used. Furthermore, according to various implementations, the components described herein may be implemented in hardware and/or software that configure hardware.

For simplicity and illustrative purposes, the disclosure included descriptions that may refer to examples. In the description, numerous specific details have been set forth in object to provide a thorough understanding of the present disclosure. It will be readily apparent however, that the disclosure may be practiced without limitation to these specific details. In other instances, some methods and structures have not been described in detail so as not to unnecessarily obscure the present disclosure. In some instances, various method operations may be omitted and the various method operations are not necessarily performed in the object in which they are presented.

Throughout the disclosure, the term “a” and “an” may be intended to denote at least one of a particular element. As used herein, the term “includes” means includes but not limited to, the term “including” means including but not limited to. The term “based on” means based at least in part on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. As such, the disclosure is intended to be defined by the following claims—and their equivalents—in which all terms are meant in their broadest reasonable sense unless otherwise indicated.

What is claimed is:

1. A system, comprising:
a processor programmed to:
access a message comprising an order and a plurality of codes, wherein unique combinations of one or more codes, from among the plurality of codes, each define a choice of codes that is to be searched against a second plurality of codes, and wherein permutations of pairwise checks between the choice of codes and the second plurality of codes define a search space to be explored;
apply one or more bounds to reduce the search space for exploration;
execute a Deep-First Search (“DFS”) with backtracking on the reduced search space until an optimum objective for each choice of code from among the plurality of codes is found; and
identify a permutation of orders based on the codes that gave the optimum objective for each choice of code derived from the unique combinations of one or more codes.

2. The system of claim 1, wherein the order relates to a taker order and wherein to apply the one or more bounds to reduce the search space, the processor is further programmed to:
access an order book having a plurality of maker orders that can potentially be matched with the taker order, each maker order being associated with a corresponding code;
generate a template that guides DFS exploration, the template ignoring any maker order in the book that does not have a bilateral relationship with the taker order based on the plurality of codes and the corresponding code; and
provide the template for input to the DFS.

3. The system of claim 2, wherein a size of an order is smaller than a lot size of an instrument to which the order pertains, and wherein to apply the one or more bounds to reduce the search space, the processor is further programmed to:
consider only combinations of orders in a given slot of the template.

4. The system of claim 2, wherein to generate the template, the processor is further programmed to:
select a maker order having the highest priority in the order book;
select a code from among the unique combination;
match the maker order and the taker order;
perform a reversible drawdown of credit between the maker order and the taker order; and
add the match to the template.

5. The system of claim 1, wherein to apply the one or more bounds to reduce the search space, the processor is further programmed to:
determine a benchmark price that facilitates early termination of the DFS.

6. The system of claim 1, wherein the message comprises one or more preferences over the plurality of codes, and wherein the processor is further programmed to:
rank the order of use of the plurality of codes based on the one or more preferences.

7. The system of claim 6, wherein the rank is based on a preferred ranking order.

8. The system of claim 6, wherein the rank is based on a least preferred ranking order.

9. The system of claim 1, wherein the order relates to a taker order and wherein to apply the one or more bounds to reduce the search space, the processor is further programmed to:
access an order book having a plurality of maker orders that can potentially be matched with the taker order, each maker order being associated with a corresponding code; and
during execution of the DFS, pass an order pair comprising a maker order and the taker order to a credit engine to check current credit drawdowns associated with the pair to further reduce the search space.

10. A method, comprising:
accessing, by a processor, a message comprising an order and a plurality of codes, wherein unique combinations of one or more codes, from among the plurality of codes, each define a choice of codes that is to be searched against a second plurality of codes, and wherein permutations of pairwise checks between the choice of codes and the second plurality of codes define a search space to be explored;
applying, by the processor, one or more bounds to reduce the search space for exploration;
executing, by the processor, a Deep-First Search (“DFS”) with backtracking on the reduced search space until an optimum objective for each choice of code from among the plurality of codes is found; and
identifying, by the processor, a permutation of orders based on the codes that gave the optimum objective for each choice of code derived from the unique combinations of one or more codes.

11. The method of claim 10, wherein the order relates to a taker order and wherein to apply the one or more bounds to reduce the search space, the method further comprising:
accessing an order book having a plurality of maker orders that can potentially be matched with the taker order, each maker order being associated with a corresponding code;
generating a template that guides DFS exploration, the template ignoring any maker order in the book that does not have a bilateral relationship with the taker order based on the plurality of codes and the corresponding code; and
providing the template for input to the DFS.

12. The method of claim 11, wherein a size of an order is smaller than a lot size of an instrument to which the order pertains, and wherein to applying the one or more bounds to reduce the search space comprises:
considering only combinations of orders in a given slot of the template.

13. The method of claim 11, wherein generating the template comprises:
selecting a maker order having the highest priority in the order book;
selecting a code from among the unique combination;
matching the maker order and the taker order;
performing a reversible drawdown of credit between the maker order and the taker order; and
adding the match to the template.

14. The method of claim 10, wherein applying the one or more bounds to reduce the search space comprises:
determining a benchmark price that facilitates early termination of the DFS.

15. The method of claim 10, wherein the message comprises one or more preferences over the plurality of codes, the method further comprising:
ranking the order of use of the plurality of codes based on the one or more preferences.

16. The method of claim 15, wherein the rank is based on a preferred ranking order.

17. The method of claim 15, wherein the rank is based on a least preferred ranking order.

18. The method of claim 10, wherein the order relates to a taker order and wherein applying the one or more bounds to reduce the search space comprises:
accessing an order book having a plurality of maker orders that can potentially be matched with the taker order, each maker order being associated with a corresponding code;
during execution of the DFS, pass an order pair comprising a maker order and the taker order to a credit engine to check current credit drawdowns associated with the pair to further reduce the search space.

19. A non-transitory computer readable medium storing instructions that, when executed by a processor, programs the processor to:
access a message comprising an order and a plurality of codes, wherein unique combinations of one or more codes, from among the plurality of codes, each define a choice of codes that is to be searched against a second plurality of codes, and wherein permutations of pairwise checks between the choice of codes and the second plurality of codes define a search space to be explored;
apply one or more bounds to reduce the search space for exploration;
execute a greedy heuristic to iterate through an order book to select matching contra-orders until an optimum objective for each choice of code from among the plurality of codes is found; and
identify a permutation of orders based on the matching contra-orders.

20. The non-transitory computer readable medium of claim 19, wherein the instructions when executed further programs the processor to:
execute a Deep-First Search (“DFS”) with backtracking on the reduced search space until an optimum objective for each choice of code from among the plurality of codes is found; and
identify a second permutation of orders based on the codes that gave the optimum objective for each choice of code derived from the unique combinations of one or more codes, wherein the second permutation of orders is to replace the permutation of orders.
